(19) United States
(12) Patent Application Publication
(10) Pub. No.: US 2018/0168008 A1
(43) Pub. Date: Jun. 14, 2018

(54) COOKING APPARATUS

(71) Applicant: NXP USA, Inc., Austin, TX (US)

(72) Inventors: Pierre Marie J. Piel, Chandler, AZ (US); Daniel Viza, Phoenix, AZ (US)

(21) Appl. No.: 15/374,489

(22) Filed: Dec. 9, 2016

(51) Int. Cl. H05B 6/66

(52) U.S. Cl. CPC H05B 6/664; H05B 2206/044

(57) ABSTRACT

A cooking apparatus is provided. The cooking apparatus includes a cooking surface and a plurality of antennas coupled to the cooking surface. Each antenna in the plurality of antennas is configured to radiate radio frequency energy to generate heat in food over the cooking surface. The cooking apparatus includes a radio frequency power module configured to transmit electrical signals to the plurality of antennas to cause each antenna in the plurality of antennas to radiate the radio frequency energy.

### TECHNICAL FIELD

Embodiments of the subject matter described herein relate generally to electronic circuits, and more particularly, to devices employing integrated radio frequency (RF) power modules for transmitting radio frequency energy for use in conjunction with a cooking apparatus and other system.

### BACKGROUND

A kitchen stove is designed for the purpose of cooking food. Kitchen stoves having top burners are known as cook-top kitchen stoves. Kitchen stoves rely on the application of direct heat for the cooking process. Natural gas and electricity are the most common heating resources for kitchen stoves. However, kitchen stoves that use natural gas and electricity for heating are generally inefficient and often do not cook food evenly. Thus, it may be preferable to develop clean and efficient heating resources for kitchen stoves that enable precise management of the cooking process.

Magnetrons can be used to generate energy for the purpose of heating food in a microwave oven. A magnetron essentially consists of a circular chamber with multiple cylindrical cavities spaced around its rim, a cathode built into the center of the chamber, and a magnet configured to generate a magnetic field. When incorporated into a microwave oven, the cathode is coupled to a direct current (DC) power supply that is configured to provide a high voltage potential to the cathode. For example, the power supply may be required to provide four kilovolts or more to the cathode. The magnetic field and the cylindrical cavities cause electrons within the cavity to induce a resonant, high-frequency radio frequency field in the cavity, and a portion of the field may be extracted from the cavity via a probe. A waveguide coupled to the probe directs the radio frequency energy to a load. For example, in a microwave oven, the load may be a heating chamber, the impedance of which may be affected by objects within the heating chamber.

Compared with kitchen stoves that use natural gas and electricity as heating sources, heating applications based on magnetron radio frequency power devices are cleaner, more efficient and more controllable. However, technical challenges exist for safely and efficiently implementing heating applications based on magnetron radio frequency power devices.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is a top view of a cook-top kitchen stove, in accordance with an example embodiment.

FIG. 2 is a cross-sectional, side view illustrating a power module used for the cook-top kitchen stove.

FIG. 3 is side view of the cook-top kitchen stove of FIG. 1.

FIG. 4 is a cross-sectional view illustrating detail of the channel in the surface of the cook-top kitchen stove.

FIG. 5 is a block diagram depicting functional components of a power module that may be used in conjunction with the cook-top kitchen stove.

FIG. 6 shows changes in the relative permittivity curve (Er) for food during the cooking process.

FIG. 7 is a flowchart depicting a method that may be implemented by a controller of a cook-top kitchen stove to cook food to a desired doneness level.

FIGS. 8A and 8B are pictures depicting hot and cold spots that may develop within food being cooked in a cooking appliance.

FIG. 9 is a flowchart depicting a method that may be implemented by a controller of a cook-top kitchen stove to cook food in a manner that can reduce the formation of hot and cold spots.

FIG. 10 is a flowchart depicting an alternative method that may be implemented by a controller of a cook-top kitchen stove to cook food to a desired doneness level.

### DETAILED DESCRIPTION

The following detailed description is merely illustrative in nature and is not intended to limit the embodiments of the subject matter or the application and uses of such embodiments. As used herein, the words “exemplary” and “example” mean “serving as an example, instance, or illustration.” Any implementation described herein as exemplary or an example is not necessarily to be construed as preferred or advantageous over other implementations. Furthermore, there is no intention to be bound by any expressed or implied theory presented in the preceding technical field, background, or the following detailed description.

Embodiments of the subject matter described herein relate to radio frequency power modules that can be used in cook-top kitchen stoves. Embodiments of the subject matter include a cooking apparatus that includes a cooking surface. A number of radiating elements containing antennas are installed into or otherwise coupled to or integrated with the cooking surface. Radio frequency power modules are configured to supply a high energy radio frequency signal to the antennas, which, in turn, radiate corresponding radio frequency energy into a heating chamber of the cooking apparatus. That energy is ultimately communicated into food placed on the cooking surface to cook the food.

As used herein, the term food may refer to any substance that may be heated or otherwise cooked by the present cook-top kitchen stove. As such, references to the heating of food are to be understood to include the heating of objects, such as cookware, heating pads, liquids, plastics, and other objects. Generally, the term food, as used herein, is sufficiently broad to include all substances that have relative permittivities (Er) that are greater than 0, enabling those substances to absorb the radio energy emitted by the cook-top kitchen stove's radiating elements.

The cooking apparatus may include a lid configured to be placed over the cooking surface and the cooking apparatus' radiating elements. The lid can be made of a material configured to reflect the radio frequency energy radiated by the radiating elements. As such, that radio frequency energy is maintained within the volume defined by the lid and the cooking surface.

In various embodiments, the radio frequency power modules may include or be connected to sensors configured to detect the amount of radio frequency energy being reflected by the lid of the cooking apparatus within the heating chamber. As described herein, the amount of reflected energy is affected by how much of that radio frequency energy is absorbed by the food in the cooking apparatus. The amount of radio frequency energy absorbed by the food can change as the food cooks. Specifically, as the food cooks, the food's relative permittivity changes. By monitoring the amount of reflected radio frequency energy and, implicitly, the relative permittivity of the food, it is possible to predict the degree to which the food in the cooking apparatus has been cooked. This information can, in turn, be used to control the amount of radio frequency energy being delivered into the food via the cooking apparatus' radiating elements. As such, it may be possible to automatically cook a particular type of food to a desired “doneness” by determining and monitoring changes in the food's relative permittivity.

As described below, embodiments of power modules incorporated into the present cooking apparatus can be implemented using a signal generator that generates signals at a particular frequency and an amplifier that amplifies those signals to increase their respective magnitude or power. The amplified radio frequency signals are then communicated to antennas that convert the radio frequency signals into radio frequency waves or energy that radiates from the antennas into a volume enclosed by a lid. A power controller then adjusts the radio frequency signals to be generated and amplified based upon the detected magnitude of reflected radio frequency energy.

Although the description herein discusses, in detail, the use of various embodiments of radio frequency power modules in cook-top kitchen stove applications, it is to be understood that the various embodiments of radio frequency power modules may be used in other types of systems, as well (e.g., radar systems, communication systems, and so on). Therefore, the applications described in detail herein are not meant to limit the applicability of the various embodiments only to cook-top kitchen stove applications.

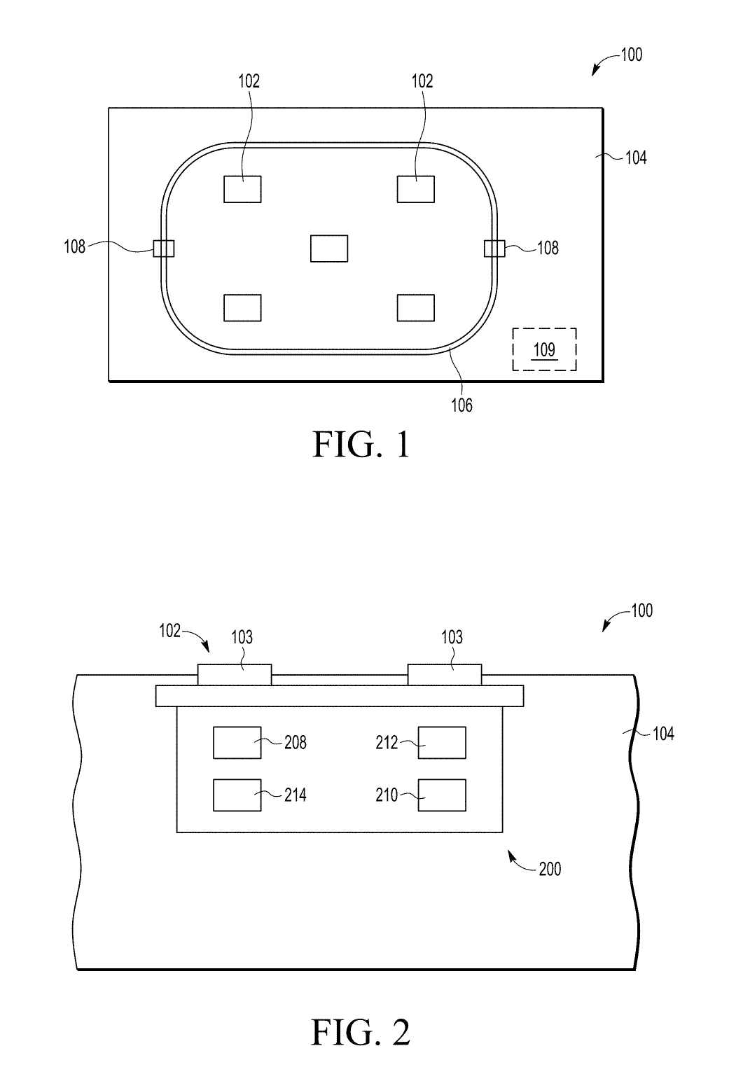

FIG. 1 is a top view of a cook-top kitchen stove 100, in accordance with an example embodiment. As shown in FIG. 1, radiating elements 102 are placed on or otherwise coupled to or integrated into a substantially planar cooking surface 104. Cooking surface 104 may be made of non-conductive materials such as ceramic or glass. Each radiating element 102 includes an antenna configured to radiate radio frequency energy into a volume over the cooking surface 104 and, specifically, into food (not shown) that can be placed on or over cooking surface 104. As the radio frequency energy radiated from each radiating element 102 is communicated into the food, the food on the cooking surface 104 may be heated and is thus cooked. The antennas of each radiating element 102 may be made of metal and may be formed over or printed upon a printed circuit board (PCB) that is, in turn, mounted to cooking surface 104. The metal that the antennas are made of may include copper, steel or aluminum. The PCB may be a laminated board having a metal layer placed on the top of the laminated board forming the antennas. The antennas of each radiating element 102 may include, for example, dipole antennas, patch antennas, microstrip antennas, slot antennas, or another type or configuration of antennas that are suitable for radiating microwave radio frequency energy.

Each radiating element 102 may be a smart cooking unit configured to radiate radio frequency energy having variable magnitude, variable frequency and/or variable relative phase as compared to the radio frequency energy radiated by other radiating elements 102. Radiating elements 102 may include logic circuits that are configured to adjust the magnitude, frequency, and/or relative phase of the radio frequency energy being generated by each radiating element 102 based upon data received from sensors incorporated into the cook-top kitchen stove 100. The logic circuits may include one or more general purpose or special purpose processors (e.g., a microprocessor, microcontroller, Application Specific Integrated Circuit (ASIC), and so on), volatile and/or non-volatile memory (e.g., Random Access Memory (RAM), Read Only Memory (ROM), flash, various registers, and so on), one or more communication busses, and other components.

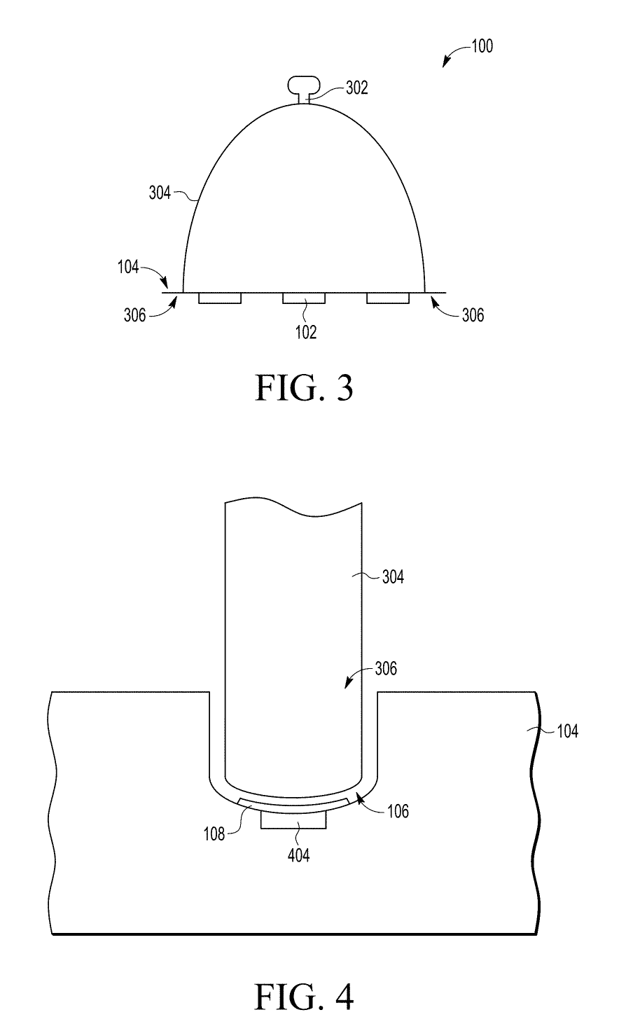

As depicted in FIG. 1, cooking surface 104 includes a channel 106. Channel 106 is formed around the radiating elements 102 on the cooking surface 104 (i.e., channel 106 surrounds the radiating elements 102). Channel 106 may take the form of a channel or groove having a semi-circular cross-section, though other shapes and configurations, such as a substantially square or rectangular channel may instead be formed around radiating elements 102. Channel 106 is generally configured to receive a portion of a rim of a lid that may be placed over radiating elements 102. Generally, the lid has a rim configured to be inserted into and retained within channel 106. More details of the lid and channel 106 are described below with respect to FIG. 3 and FIG. 4.

Cooking surface 104 of cook-top kitchen stove 100 includes sensors 108 to monitor channel 106. Specifically, sensors 108 are configured to detect when the lid has been placed into channel 106. Sensors 108 may include, for example, one or more contact or magnetic sensors configured to detect and verify that the lid has been placed into channel 106 and/or is making contact with channel 106. Sensors 108 are coupled to controller 109. If controller 109, using data received from sensors 108, determines that the lid is in place, controller 109 can enable radiating elements 102 to operate and deliver radio frequency energy into the volume enclosed by the lid over cooking surface 104 (i.e., the heating chamber). If, however, controller 109 determines that the lid is not in place, controller 109 inhibits the operation of radiating elements 102. If, while a cooking process is ongoing, sensors 108 indicate that the lid is no longer in contact with channel 106, or the lid is partially removed from channel 106, controller 109 may cause radiating elements 102 to stop radiating radio frequency energy.

FIG. 2 is a cross-sectional, side view of a portion of cook-top kitchen stove 100 depicting power module 200 that is mounted to cooking surface 104. As shown in FIG. 2, radiating element 102 is mounted to the bottom surface of cooking surface 104. As described above, radiating element 102 may include one or more antennas 103 made of metal or a metal-plated PCB that is used for radiating radio frequency waves to heat food placed on the cooking surface 104.

Radiating element 102 may be driven by power module 200. As shown in FIG. 2, power module 200 may be attached to the bottom of the radiating element 102. Power module 200 may include a signal generator 208 that generates radio frequency signals at a particular frequency. For example, power module 200 may generate radio frequency signals having frequencies in a range of about 2.0 gigahertz (GHz) to about 3.0 GHz. In other embodiments, the radio frequency signals may have frequencies ranging from 12 megahertz (MHz) to 48 MHz. Signal generator 208 may generate radio frequency signals in other frequency ranges, in still other example embodiments. Power module 200 may also include an amplifier 210 that amplifies the radio frequency signals to increase the magnitude of the radio frequency signals. The amplified radio frequency signals are then fed to antennas 103, which radiate the radio frequency signals as radio frequency energy.

As described in more detail below, power module 200 may include power sensor 212 that detects reflected radio frequency energy. The reflected radio frequency energy may originate from antenna 103 and then ultimately be reflected back to power sensor 212 from a reflector positioned over antennas 103. The reflector may be the lid of cook-top kitchen stove 100 placed on cooking surface 104.

Power module 200 further includes power controller 214. Based on the reflected radio frequency energy detected by power sensor 212, power controller 214 may adjust the frequency, the magnitude and/or the relative phase of radio frequency signals to be generated and outputted by power module 200 in order to control the radiation of radio frequency energy while generating enough heat for the food.

FIG. 3 is side view of cook-top kitchen stove 100 including lid 304. As depicted, lid 304 has a domed shape, though lid 304 may take other shapes suitably configured to enclose a heating chamber volume over radiating elements 102. For example, lid 304 may have a cylindrical, cubic, pyramid or cone shape other than the dome shape. Lid 304 is sized to cover radiating elements 102 when lid 304 is placed on cooking surface 104. Lid 304 has an edge or rim 306 that is configured to fit within channel 106 formed within cooking surface 104. As described above, cook-top kitchen stove 100 may include a number of sensors configured to detect that lid 304 is properly placed over cooking surface 104 and the rim of lid 304 is positioned within channel 106.

Lid 304 operates to contain radio frequency energy generated by radiating elements 102 within the volume defined by the interior of lid 304 and cooking surface 104. Lid 304 is made of materials or may be coated with materials that can block and reflect radiated radio frequency energy when lid 304 is placed over radiating elements 102. For example, lid 304 may be made of metal materials such as copper, aluminum or steel. Lid 304 may also be made of or coated with non-metal materials that may block and reflect radio frequency waves such as dielectrics including tin oxides. Examples of dielectrics include plastic, Polytetrafluoroethylene (PTFE), glass and ceramic, or other suitable reflective or absorbing materials.

Lid 304 may have other features or attached components. For example, camera 302 may be mounted to an underside of lid 304. Camera 302 may be used to capture an image underneath lid 304 when the lid 304 is in contact with the cooking surface 104 and food on cooking surface 104 is being cooked by radio frequency energy radiated from radiating elements 102. The image captured by camera 302 may be transmitted (e.g., wirelessly or via a wired connection) to a device, such as a mobile computing device, or display unit, suitably configured to display the image captured by camera 302. The image can then be viewed by the user to monitor the cooking process. Camera 302 may be a conventional camera configured to capture images using visible light. In that case, an illumination device may be incorporated into camera 302 to illuminate the food being cooked and to facilitate image capture by camera 302. In other cases, camera 302 may be configured to capture images using infrared light. In that case, the images captured by camera 302 may use the infrared image to provide information about the current temperature of the food being cooked, for example.

FIG. 4 is a cross-sectional view showing additional detail of channel 106 formed in cooking surface 104 of cook-top kitchen stove 100. Channel 106 may be a semi-circular groove that is formed in cooking surface 104 surrounding the radiating elements 102. Channel 106 is generally shaped to match and receive at least a portion of the rim 306 of lid 304.

As described above, sensor 108 is configured to detect when the rim of lid 304 has been positioned within channel 106. Sensor 108 may include any contact, proximity, or other type of sensor configured to detect the presence of the rim of lid 304. To facilitate the contact between the rim 306 of lid 304 and channel 106, a magnet 404 may be placed inside a portion of channel 106. When the cook-top cover is made of metal, rim 306 is in magnetic engagement with channel 106 when rim 306 is positioned within channel 106.

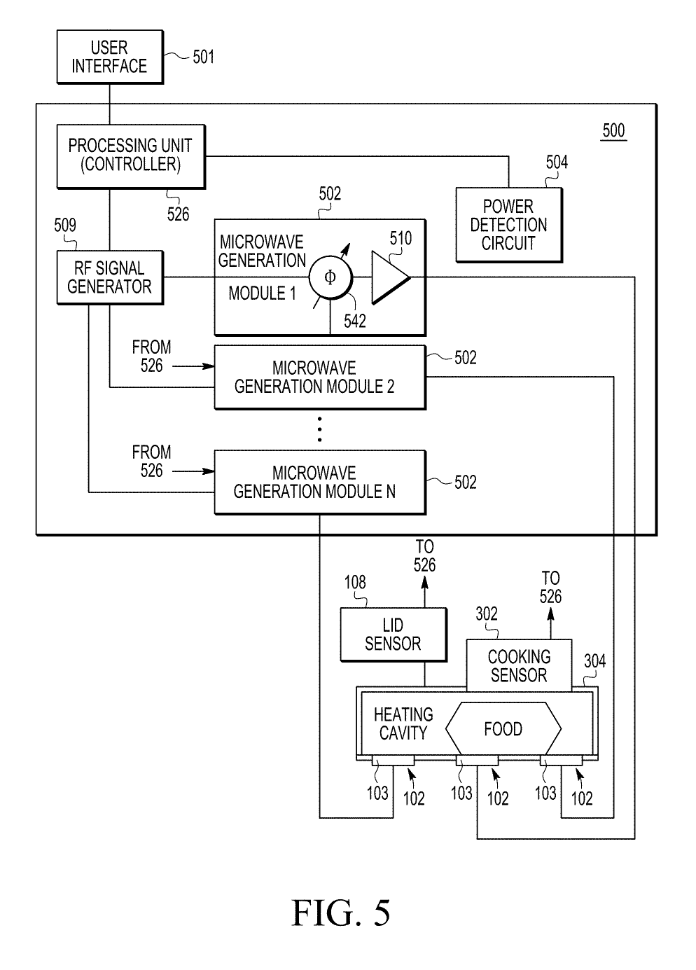

FIG. 5 is an example block diagram depicting a cooking system including power module 500 to control the radio frequency energy radiated by the antennas 103 of radiating elements 102 therein. Cook-top kitchen stove 100 may include a single power module 500 that is configured to supply radio frequency signals to each radiating element 102 in cook-top kitchen stove 100. In that case, the radio frequency signal generated by power module 500 may be split two or more times into two separate signals for transmission to two or more separate antennas. The split signals may then optionally be individually amplified and/or adjusted (e.g., by modifying a magnitude, frequency or relative phase of any of the signals) and separately delivered to each radiating element 102. Alternatively, cook-top kitchen stove 100 may include a number of separate power modules 500, where each power module 500 is associated with a single antenna 103 or a subset of the total number of antennas 103 in cook-top kitchen stove 100.

Power module 500 may operate according to input received via a suitably configured control panel or user interface 501, by which a user may input a desired cooking activity. For example, the user may specify that food be cooked to a particular temperature for a particular period of time. Alternatively, the control panel may enable a user to specify that the food be cooked until a desired level of doneness is achieved—that approach is described in more detail below. In such a case, the control panel may optionally enable the user to enter a type of food that is being cooked, enabling the desired level of doneness to be achieved relatively accurately. After the user has specified a desired cooking activity via user interface 501, power module 500 will operate to cook food in cook-top kitchen stove 100 in accordance with the instructions received via user interface 501. More specifically, power module 500 will supply a radio frequency signal to radiating elements 102 to cause antennas 103 of radiating elements 102 to radiate radio frequency energy into the heating chamber of cook-top kitchen stove 100 for a period of time and at a power level that is consistent with the user inputs.

As shown in FIG. 5, power module 500 includes microwave generation modules 502, power detection component 504, and controller (e.g., a microcontroller unit (MCU)) 526.

Power module 500 includes signal generator 509 and microwave generation modules 502 . . . 502n. Each microwave generation module 502 includes an amplifier 510, which may contain a pre-driver amplifier stage, a driver amplifier stage, and a final amplifier stage. Signal generator 509 is configured to generate a radio frequency signal having a particular frequency. For example, signal generator 509 may generate signals having a frequency in a range of about 2.0 GHz to about 3.0 GHz. In embodiments of cook-top kitchen stove 100 having multiple power modules 500, each power module 500 (and, more specifically, microwave generation modules 502 of each power module 500) may be configured to generate radio frequency signals having frequencies of about 2.45 GHz, where the frequency of the signal outputted by signal generator 509 may be determined by controller 526. Although each power module 500 may generate radio frequency signals of approximately the same frequency or wavelength, various power modules 500 in cook-top kitchen stove 100 may radiate energy of different frequencies from each other, as well.

Within amplifier 510, the pre-driver amplifier may be used to amplify the radio frequency signals outputted by signal generator 509 to a predetermined level. For example, the pre-driver amplifier may amplify the radio frequency signals to a power level of about 1 watt or some other power level. The driver amplifier and the final amplifier stage may amplify the amplified radio frequency signals received from the pre-driver amplifier to power levels that are different from the pre-driver amplifier. For example, the driver amplifier may amplify the radio frequency signal to about a 9 watt signal and the final amplifier stage may amplify the radio frequency signal to a power level in a range of about 100 watts to about 200 watts (e.g., about 156 watts). Each of the amplifier stages of amplifier 510 may apply more or less gain to the respective received signals, and/or one or more of the amplifier stages may be excluded from the system 100.

The amplified radio frequency signal generated by microwave generation module 502 is ultimately communicated to the antennas 103 of cook-top kitchen stove 100. As illustrated in FIG. 5, the signal outputted by RF signal generator 509 can be split into multiple separate signals of about equal magnitude (though the signal could be split into multiple signals of dissimilar magnitude, depending upon the system implementation) and supplied to independent microwave generation modules 502. In the example shown in FIG. 5, the signal outputted by RF signal generator 509 is split into n signals. In various embodiments, the signal output by RF signal generator 509 may be split into any number of separate signals of varying power levels (e.g., a number of separate signals equal to the number of antennas 103 in cook-top kitchen stove 100).

Each of the signals generated by microwave generation modules 502 may be passed through adjustable attenuators and adjustable phase shifters (collectively represent by element 542), which can be series-coupled along each path between RF signal generator 509 and antennas 103. The attenuation levels and phase shifts applied by each of the adjustable attenuators and adjustable phase shifters, respectively, can be modified by controller 526 to modify a magnitude and relative phase of the signals being supplied to antennas 103.

In various embodiments, the adjustable attenuators are each digitally controlled (e.g., by controller 526) and can have a plurality of attenuation levels where the attenuation levels are separated by a number of dB (in one embodiment, about 0.5 dB separates the attenuation levels). In one or more embodiments, the adjustable attenuators each have eight attenuation states or attenuation levels, although they may have more or fewer attenuation states or attenuation levels, in other embodiments. It will be appreciated that the adjustable attenuators may have different attenuation states, cover different attenuation ranges, and have different attenuation steps sizes from one another, although typically they may be the same. While digitally controlled, the adjustable attenuators in many embodiments are analog attenuators.

The adjustable phase shifters are each digitally controlled (e.g., by a controller 526) and have a plurality of states. In one or more embodiments, the adjustable phase shifters each have eight phase shifted states where each phase shifted state defines a particular phase shift in degrees, although they may have more or fewer phase shifted states, in other embodiments. In one example, the phase shifted states are separated by approximately 6.5 degrees. It will be appreciated that the adjustable phase shifters may have different phase shifted states, cover different ranges, and have different steps sizes from one another, although typically they may be the same. While digitally controlled, the adjustable phase shifters in many embodiments are analog phase shifters.

After the radio frequency signals have been amplifier by microwave generation modules 502, the amplified radio frequency signals are transmitted to antennas 103 at which point the signals are converted into radio frequency energy that is radiated by antennas 103.

Power module 500 includes power detection component 504. Power detection component 504 is connected to an antenna (such as antennas 103) configured to receive reflected radio frequency energy from the heating chamber of cook-top kitchen stove 100 and determine a magnitude of the reflected radio frequency energy. Power detection component 504 also may include a forward power detector, which is configured to determine an amount of radio frequency energy delivered into the heating chamber of cook-top kitchen stove 100 by microwave generation modules 502. As described below, the magnitude of the reflected radio frequency energy and/or a return loss value derived from a ratio of the magnitude of the reflected radio frequency energy over the magnitude of the radio frequency energy delivered into the heating chamber can be used to control the cooking process for different food types.

Controller 526 receives a signal from lid sensor 108 that indicates whether lid 304 has been placed over the cooking surface of cook-top kitchen stove 100. If controller 526 determines, using the signal received from lid sensor 108, that the lid is in place, controller 526 may enable microwave generation modules 502 to generate an output radio frequency signal to begin cooking food according to instructions received from user interface 501. If, however, controller 526 determines, using the signal received from lid sensor 108, that the lid is not in place, controller 526 disables microwave generation modules 502, preventing a radio frequency signal from being generated and transmitted to antennas 103.

Controller 526 is connected to a number of sensors 302 that may be incorporated into kitchen stove 100 to detect one or more attributes of food being cooked within a heating chamber of kitchen stove 100. Sensors 302 can include any sensor capable of detecting an attribute of the cooking food, such as a camera, which could detect visual changes in the appearance of the food or, if configured to detect infrared frequencies, a temperature of the food. Sensors 302 may also include a temperature sensor configured to detect a temperature of the food, which could be an infrared sensor or other type of temperature sensor.

As food is cooking, controller 526 can use sensors 302 to continuously or intermittently detect particular attributes of the food, such as the food's temperature, which can be indicative of the degree to which the food is cooked. Based upon that data, controller 526 can then control the cooking process to ensure that food is cooked to a particular level of doneness or to a particular temperature. In such a case, a user may use user interface 501 to enter a target or desired doneness level for the food to be cooked or, alternatively, the user can specify a particular target temperature that should be reached for the food.

When provided to the controller 526, the temperature information enables controller 526 to select a combination of excitation signal parameters, to alter the power of the RF signal supplied by the RF signal generator 509 (e.g., by controlling the bias and/or supply voltages provided by the power supply and bias circuitry), and/or to determine when a heating operation should be terminated.

Sensors 302 may also include one or more weight sensor positioned under the food, and configured to provide an estimate of the weight of the food to controller 526. Controller 526 may use this information, for example, to select a combination of excitation signal parameters, to determine a desired power level for the RF signal supplied by the RF signal generator 509, and/or to determine an approximate duration of a heating operation. For example, controller 526 may control the output of RF signal generator 509 in order to cook the food until a certain percentage change in the weight of the food is achieved—a value that may indicate that the food has been cooked or heated by a desired amount.

When cooking food using radio frequency energy, different types of food absorb different amounts of radio frequency energy during the cooking process. This is because different types of food exhibit different relative permittivity, which is a measure of how well the food absorbs radio frequency energy. Furthermore, not only do different types of food have different relative permittivity, but the relative permittivity of a particular type of food will change in a predictable manner as the food is cooked to different degrees. These attributes of food can be used to control the cooking process in cook-top kitchen stove 100.

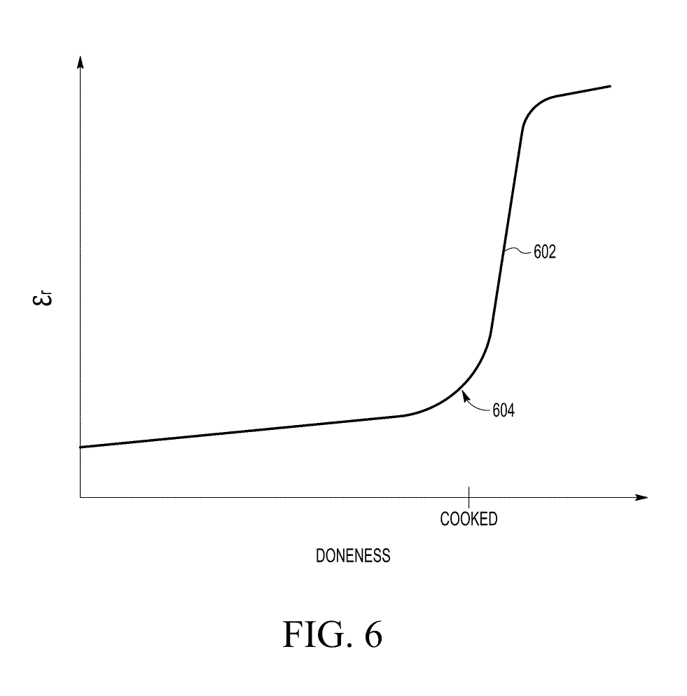

FIG. 6, for example, shows relative a permittivity curve (Er) for a typical type of food during a cooking process (the horizontal axis shows the degree to which the food is cooked). As illustrated in FIG. 6, as the food is cooked, curve 602 shows that the permittivity increases slowly during the initial cooking process. But, at point 604, the rate of change in relative permittivity increases sharply. This sharp increase in relative permittivity indicates that the food has been fully cooked.

Although many different food types can have varying relative permittivities, experiments have indicated that many food types will exhibit a similar, rapid change in relative permittivity upon becoming fully cooked.

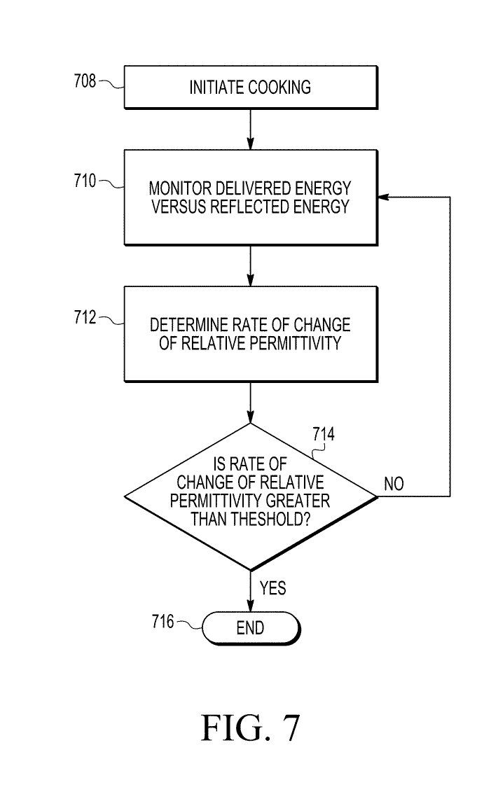

This characteristic of food—the relatively rapid change in relative permittivity as the food approaches being fully-cooked—can be utilized by the present cooking apparatus to determine when to cease the cooking process. FIG. 7, for example, is a flowchart depicting a method that may be implemented by controller 526 of cook-top kitchen stove 100 to cook food to a desired doneness level.

In step 708, the controller initiates cooking. Before initiating cooking, however, controller 526 may be configured to first implement a number of checks before cooking may take place. This may involve, for example, confirming (e.g., via lid sensor 108) that a suitable lid is in-place. Then, presuming the lid is in-place, controller 526 may sweep the heating chamber of cook-top kitchen stove 100 with radio frequency energy of a number of different frequencies and/or relative phases, while measuring that amount of reflected radio frequency energy. This step may enable controller 526 to confirm that the heating chamber is not empty and that a significant amount of metal has not been placed in the heating chamber, for example. This safety check may involve comparing the amounts of measured reflected radio frequency as the sweep is performed to a number of signature values that may have previously been determined for empty heating chambers and heating chambers that contain large amounts of metal. If the measured results match those of the signature values that may indicate an undesirable condition, and controller 526 may halt the cooking process.

After the initial checks have been performed and controller 526 has confirmed that the lid is in place, controller 526 can initiate cooking. Cooking may be initiated using, for example, default or pre-determined frequency, phase, and amplitude values for the radio frequency energy being transmitted into the heating chamber of cook-top kitchen stove 100. Alternatively, frequency, phase, and amplitude values for radio frequency energy being transmitted into the heating chamber may be determined based upon user inputs specifying particular attributes (e.g., a power level) for the cooking process.

After cooking is initiated, controller 526, in step 710, may monitor the amount of radio frequency energy being delivered into the heating chamber. This may involve, for example, monitoring a power output of one or more power modules 500 present within cook-top kitchen stove 100. Controller 526 is also configured to monitor an amount of reflected radio frequency energy within the heating chamber (e.g., detected via an antenna 103 and the reflected power detector of power detection circuit 504). In step 714, controller 526 uses the information gathered in step 710 to determine a rate of change in the relative permittivity of the food being cooked (e.g., by comparing the current value to historical values that were gathered during prior executions of step 712).

In step 714, the rate of change in the relative permittivity is compared to a threshold value. If the rate of change is less than the threshold value, that indicates that the food is not yet fully cooked (see the portion of curve 602 in FIG. 6 to the left of point 604 in which curve 602 exhibits a relatively low rate of change). If the rate of change in relative permittivity is less than the threshold, such a condition may indicate that the food has not yet reached the desired doneness level. In that case, the method returns to step 710 and the cooking process, in combination with the monitoring of delivered and reflected radio frequency energy levels, continues. The cooking process will continue until the food reaches the desired doneness level as determined by the comparison of the rate of change in the relative permittivity to the threshold value.

Accordingly, if in step 714 it is determined that the rate of change in permittivity exceeds the threshold rate, such a condition indicates the food has been fully cooked (see point 604 in curve 602 of FIG. 6). As such, the cooking process can end at step 716.

In a conventional microwave oven, food is heating by the operation of the device's magnetron. Magnetron-based microwave ovens operate at a fixed frequency (e.g., 2.45 GHz). While the microwave oven heats food, the magnetron operates at a constant frequency with essentially no variations in the phase and the frequency of microwaves generated by the device. Because the magnetron is in a fixed position within the microwave oven, this constant, unvarying operation can result in hot spots and cold spots developing within the article being heated. As such, many magnetron-based microwave ovens provide rotating platters that enable food being cooked to rotate within the microwave oven. This rotation can serve to distribute the hot and cold spots within the food being cooked. Often, however, these rotating platters are a point of frustration for end users as they are often the first component within the microwave oven to fail.

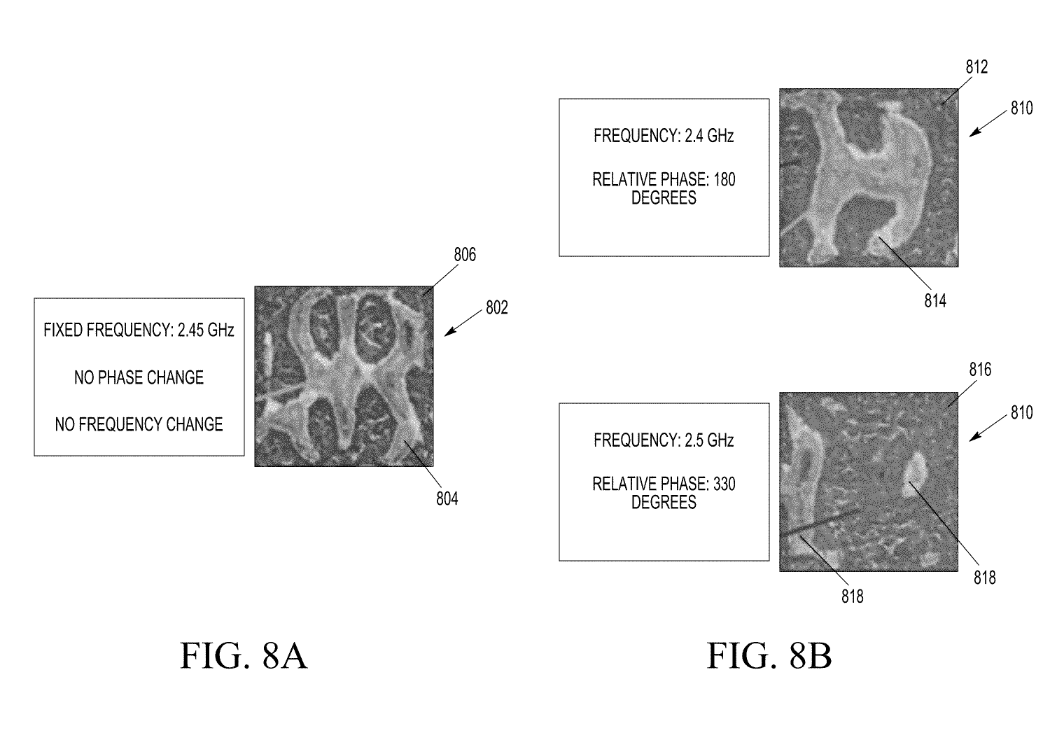

To illustrate, FIG. 8A is a picture depicting hot and cold spots that may develop within food being cooked by a conventional microwave oven. In essence, the image shown in FIG. 8A is a heat map of food article 802. In the image, region 804 contains colder portions of food article 802, while region 806 contains hotter portions of food article 802. Although, over time, heat energy will eventually move from region 806 to region 804, unless sufficient time has passed following cooking, these regions of different temperature can be quite noticeable to an end user.

To mitigate the irregular heating of food that arises in conventional microwave ovens, the present cooking apparatus may be configured to vary the relative phase and/or frequency of radio frequency energy signals delivered into the heating chamber of the cooking apparatus. As the relative phase and/or frequency of the radio frequency energy changes, the intensity of resulting radio frequency energy supplied to the food being cooked may vary positions within the food. This reduces and, in some cases, may possibly eliminate the generation of hot and cold spots within the food being cooked.

FIG. 8B, for example, includes pictures depicting the distribution of hot and cold spots that may develop within food being cooked by the present cooking device in which the frequency and/or relative phase of radio frequency energy signals delivered into the food are varied. As shown in FIG. 8B, when the present cooking apparatus operates by supplying radio frequency energy through two antennas and with a frequency of 2.4 GHz and a phase difference between the two signals of 180 degrees, hot spots can develop in region 812 of food 810 and cold spots remain in region 814 of food 810. If the frequency and phase were left unchanged, those hot spots would continue to be generated throughout the cooking process, possibly leaving region 812 over-cooked and region 814 under-cooked. But, by adjusting the amplitude, frequency and/or relative phase of the radio frequency energy signals provided to the food, higher intensity radio frequency energy may be moved within food 810 to reduce the temperature differences between the hot and cold spots.

FIG. 8B, for example, also shows an image depicting the distribution of hot and cold spots in food 810 cooked by supplying radio frequency energy through two antennas and with a frequency of 2.5 GHz and a phase shift between the two signals of 330 deg. As illustrated, hot spots develop in region 816 in food 810, while cold spots develop in regions 818. It is apparent in FIG. 8B that the locations of respective hot and cold spots do not substantially overlap from one mode of operation (2.4 GHz at 180 degrees relative phase shift) versus the other mode of operation (2.5 GHz at 330 degrees relative phase shift). As such, by adjusting the frequency and relative phase shift of the radio frequency energy signals delivered into the cooking apparatus' heating chamber while cooking enables for control over the development of hot and cold spots in the food being cooked and reduction of the same. Consequently, food being cooked in the cooking apparatus may not require rotation to be cooked evenly. In alternate embodiments, the portion of the cook top underlying the lid may be capable of rotating.

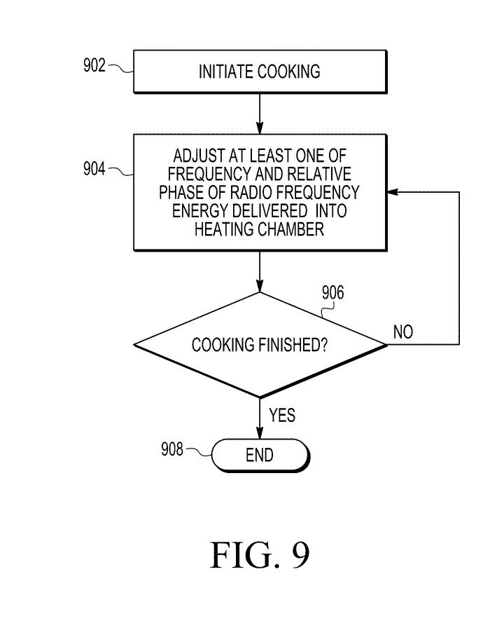

FIG. 9 is a flowchart depicting a method that may be implemented by controller 526 of cook-top kitchen stove 100 to cook food in a manner that may reduce the formation of hot and cold spots. In step 902, controller 526 initiates cooking of the food. As described above, this may involve controller 526 executing a number of preliminary checks. As cooking is ongoing, in step 904, controller 526 modifies some or all of the amplitude, the frequency, and/or the relative phase of the radio frequency energy signals being delivered into the heating chamber of cook-top kitchen stove 100. Controller 526 may make these modifications, for example, by adjusting a frequency of the radio frequency signal generated by RF signal generator 509 in power module 500. Similarly, controller 526 can adjust the relative phase of the radio frequency energy signals delivered into the heating chamber by adjusting one or more of the adjustable phase shifters. In addition, controller 526 can adjust the amplitude of the radio frequency energy delivered into the heating chamber by adjusting one or more of the variable attenuators. The adjustments could be made randomly, so as to make random changes to the amplitude, the frequency, and/or the relative phase of radio frequency energy being delivered into the heating chamber. Alternatively, controller 526 may adjust the amplitude, frequency, and/or relative phase by incrementally adjusting each of the amplitude, frequency, and/or relative phase according to a pre-determined algorithm. As discussed above, by adjusting one or more of the amplitude, frequency, and/or relative phase of the radio frequency energy, the hot spots that may be created within the food being cooked can be shifted in location, resulting in a more even distribution of heat generation within the food. This minimizes and may possibly eliminate the generation of hot and cold spots.

In step 906, controller 526 determines whether the cooking process has completed. This may involve, as described above, a determination of the amount of radio frequency energy being absorbed by the food being cooked, which can be an indicator of the doneness of the food. Alternatively, step 906 may involve determining whether a time period for cooking has expired, for example, or that the food has reached a desired temperature. If the cooking process has completed, the method moves to step 908 and the cooking process ends. If, however, cooking has not completed, the method returns to step 904 and controller 526 will continue adjusting one or more of the amplitude, frequency, and relative phase of radio frequency energy signals being used to cook the food to reduce the creation of hot and cold spots within the food.

In a similar manner, the amplitude, frequency and relative phase of the radio frequency energy signals being delivered into the heating chamber may be adjusted and controlled with the specific intent to create hot spots and cool spots within food placed within the heating chamber. When cooking a plate of food that includes many different individual types of food, or food formed from regions of different materials (e.g., meat versus bone), a user could specify (e.g., via a user interface control panel) that certain regions within the heating chamber be heated to higher temperatures than other regions. In that case, the amplitude, frequency and relative phase of radio frequency energy signals emitted by each antenna 103 in the cook-top kitchen stove 100 could be selected so that the various radio frequency waves constructively interfere with one another in regions of the heating chamber in which the user specified a higher cooking temperature, and destructively interfere with one another in regions in which a lower cooking temperature was specified.

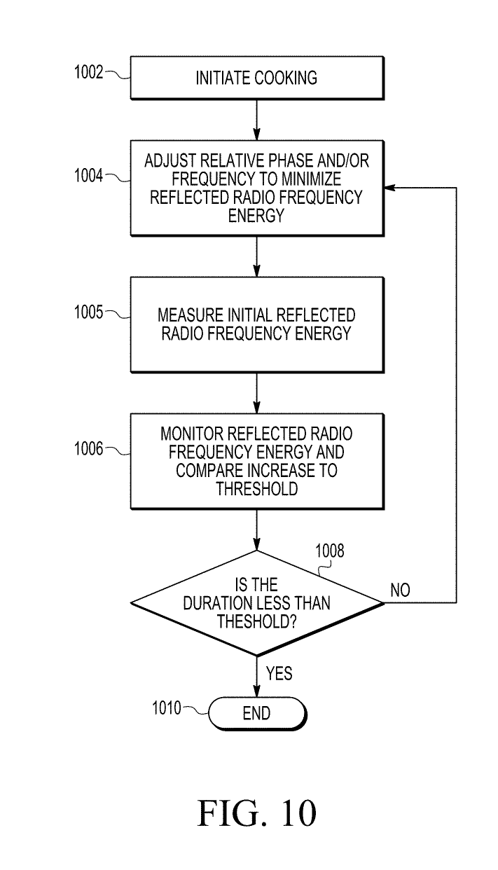

FIG. 10 is a flowchart depicting an alternative method that may be implemented by a controller of a cook-top kitchen stove to cook food to a desired doneness level. This method controls the cooking process by monitoring the efficiency of the cooking process. In one embodiment, the efficiency is indicated by an amount of reflected radio frequency energy generated during the cooking process.

In step 1002, the cooking process is initiated. As discussed above, cooking may only be initiated after executing a number of checks to ensure that the appropriate lid is in place and that the heating chamber of the cook-top kitchen stove is not empty and does not contain a large amount of metal.

In step 1004, after cooking has initiated, in an initial calibration step, the controller identifies a most efficient relative phase and frequency for the radio frequency energy signals being delivered into the heating chamber to heat the food. As part of the calibration step, the controller sweeps the relative phase and/or frequency of the radio frequency energy being delivered into the heating chamber through a number of values. The sweep may involve changing or modify the relative phase and/or frequency randomly, or through a number of pre-determined values. This sweeping step is performed in order to identify the most efficient combination of relative phase and frequency for the radio frequency energy being used to cook the food. This may involve identifying the combination of relative phase and frequency values that result in the lowest reflected radio frequency energy measurement (e.g., as determined by reflected power detector 524).

After a number of different relative phase and frequency values have been swept, and the combination that results in the lowest reflected radio frequency energy measurement is identified (i.e., the most efficient combination), the cooking process continues using those frequency and relative phase values. In step 1005, following calibration step 1004, an initial measurement of reflected radio frequency energy is taken in step 1005.

As the food cooks, the food's relative permittivity changes, which, in turn, can reduce the efficiency of the cooking process. This manifests as an increase the amount of reflected radio frequency energy (i.e., energy that is not being absorbed by the food). As such, in step 1006, the amount of reflected radio frequency energy is continually monitored since the calibration step 1004 and initial measurement step 1005. As part of the monitoring step 1006, the controller compares the current measurement of reflected radio frequency energy to the amount that was measured following the calibration step in initial measurement step 1005. As cooking continues, the current measurement of reflected radio frequency will increase as the relative permittivity of the food changes. Eventually, as measured in step 1006, the measured reflected radio frequency energy will have increased by an amount greater than a threshold amount over the initial measurement made in 1005.

After it is determined in step 1006 that the amount of reflected radio frequency energy has increased by the threshold amount (and, correspondingly, the efficiency of the cooking process has fallen by a sufficient amount due to the increases in reflected radio frequency energy), in step 1008 the controller determines whether a particular time duration has passed since the last time the calibration step 1004 was executed. If sufficient time has passed, that indicates that the relative permittivity of the food is not changing at a rapid rate and that the cooking process is still on-going. As such, if the duration has passed, the method returns to step 1004 and another calibration is performed and the method repeats. If, however, the duration has not passed (indicating that it didn't take very long for the reflected radio frequency energy to increase by the threshold amount), that indicates that the relative permittivity of the food may be changing at a rapid rate and, consequently, the food may be fully cooked (see the rapid change in permittivity to the right of point 604 on curve 602 of FIG. 6). In that case, the cooking process ends in step 1010.

In an embodiment, a cooking apparatus includes a cooking surface and a plurality of antennas coupled to the cooking surface. Each antenna in the plurality of antennas is configured to radiate radio frequency energy to generate heat in food over the cooking surface. The cooking apparatus includes a radio frequency power module configured to transmit electrical signals to the plurality of antennas to cause each antenna in the plurality of antennas to radiate the radio frequency energy.

In another embodiment, a radio frequency power module for a cooking apparatus includes a signal generator configured to generate a radio frequency signal, an amplifier connected to the signal generator and configured to amplify the radio frequency signal into an amplified radio frequency signal, and an antenna coupled to a cooking surface of the cooking apparatus. The antenna is connected to the amplifier and configured to receive the amplified radio frequency signal and radiate corresponding radio frequency energy. The power module includes a power sensor configured to detect a magnitude of a reflected radio frequency energy, and a power controller configured to modify a magnitude of the amplified radio frequency signal based at least in part upon the magnitude of the reflected radio frequency energy.

In another embodiment, a method includes generating a first radio frequency signal and a second radio frequency signal, supplying the first radio frequency signal to a first antenna of a cooking surface to cause the first antenna to radiate first radio frequency energy to generate heat in food over the cooking surface, and supplying the second radio frequency signal to a second antenna of the cooking surface to cause the second antenna to radiate second radio frequency energy to generate heat in the food on the cooking surface.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A cooking apparatus, comprising:
a cooking surface;
a plurality of antennas coupled to the cooking surface, each antenna in the plurality of antennas being configured to radiate radio frequency energy to generate heat in food over the cooking surface; and
a radio frequency power module configured to transmit electrical signals to the plurality of antennas to cause each antenna in the plurality of antennas to radiate the radio frequency energy.

2. The cooking apparatus of claim 1, including a lid configured to be placed on the cooking surface over the plurality of antennas, the lid including a material configured to reflect the radio frequency energy emitted by each antenna of the plurality of antennas.

3. The cooking apparatus of claim 2, wherein the radio frequency power module includes a power detector configured to detect a magnitude of radio frequency energy within a volume at least partially defined by the lid.

4. The cooking apparatus of claim 3, wherein the radio frequency power module is configured to modify the electrical signal transmitted to at least one antenna in the plurality of antennas based upon the magnitude of the radio frequency energy within the volume at least partially defined by the lid.

5. The cooking apparatus of claim 2, wherein the cooking surface includes a contact sensor configured to detect the lid placed on the cooking surface over the plurality of antennas.

6. The cooking apparatus of claim 5, wherein the contact sensor is coupled to the radio frequency power module and the radio frequency power module does not transmit the electrical signal to the plurality of antennas to cause each antenna in the plurality of antennas to radiate the radio frequency energy when the contact sensor does not detect the lid.

7. The cooking apparatus of claim 5, wherein the cooking surface includes a channel configured to receive an edge of the lid and the contact sensor is disposed within the channel.

8. The cooking apparatus of claim 2, including a camera mounted to the lid, the camera being configured to capture an image of the food when the lid is placed over the plurality of antennas.

9. The cooking apparatus of claim 1, wherein the radio frequency power module is configured to modify at least one of a frequency and a phase of the radio frequency energy.

10. The cooking apparatus of claim 1, wherein an antenna in the plurality of antennas includes a patch antenna, a microstrip antenna, a dipole antenna, or a slot antenna.

11. The cooking apparatus of claim 1, wherein the radio frequency energy has a frequency in a range of 800 megahertz (MHz) to 300 gigahertz (GHz).

12. A radio frequency power module for a cooking apparatus, comprising:
a signal generator configured to generate a radio frequency signal;
an amplifier connected to the signal generator and configured to amplify the radio frequency signal into an amplified radio frequency signal;
an antenna coupled to a cooking surface of the cooking apparatus, the antenna being connected to the amplifier and configured to receive the amplified radio frequency signal and radiate corresponding radio frequency energy;
a power sensor configured to detect a magnitude of a reflected radio frequency energy; and
a power controller configured to modify a magnitude of the amplified radio frequency signal based at least in part upon the magnitude of the reflected radio frequency energy.

13. The radio frequency power module of claim 12, wherein the reflected radio frequency energy is reflected by a lid positioned over the antenna.

14. The radio frequency power module of claim 13, including:
a signal splitter coupled to the amplifier and configured to split the amplified radio frequency signal into a first and second amplified radio frequency signals, wherein the first amplified radio frequency signal is provided to the amplifier; and
a second antenna configured to receive the second amplified radio frequency signal and radiate corresponding second radio frequency energy.

15. The radio frequency power module of claim 12, including a phase shifter coupled to the amplifier and wherein the power controller is configured to modulate a phase of the amplified radio frequency signal using the phase shifter.

16. The radio frequency power module of claim 12, wherein a frequency of the radio frequency signal is in a range of 800 megahertz (MHz) to 300 gigahertz (GHz).

17. The radio frequency power module of claim 12, wherein the antenna includes a patch antenna, a microstrip antenna, a dipole antenna, or a slot antenna.

18. A method, comprising:
generating a first radio frequency signal and a second radio frequency signal;
supplying the first radio frequency signal to a first antenna of a cooking surface to cause the first antenna to radiate first radio frequency energy to generate heat in food over the cooking surface; and
supplying the second radio frequency signal to a second antenna of the cooking surface to cause the second antenna to radiate second radio frequency energy to generate heat in the food on the cooking surface.

19. The method of claim 18, including:
detecting whether a lid is positioned on the cooking surface over the first antenna and the second antenna; and
when the lid is not detected on the cooking surface over the first antenna and the second antenna, preventing the first radio frequency signal from being supplied to the first antenna and preventing the second radio frequency signal from being supplied to the second antenna.

20. The method of claim 18, including:
detecting a magnitude of a reflected radio frequency signal; and
modulating an amplitude of at least one of the first radio frequency signal and the second radio frequency signal based on the magnitude of the reflected radio frequency signal.
